(19) United States
(12) Patent Application Publication
(10) Pub. No.: US 2018/0132061 A1
(43) Pub. Date: May 10, 2018

(54) ENHANCING POSITIONING ASSISTANCE DATA VIA A MOBILE DEVICE-SPECIFIC CARRIER AGGREGATION CAPABILITY

(71) Applicant: QUALCOMM Incorporated, San Diego, CA (US)

(72) Inventors: Suresh Kumar Bitra, Mangalagiri (IN); Arun Kumar Sharma Tandra, Hyderabad (IN); Naveen Kumar Aravapalli, Hyderabad (IN)

(21) Appl. No.: 15/348,303

(22) Filed: Nov. 10, 2016

(51) Int. Cl. H04W 4/02; H04W 72/04; H04L 5/00

(52) U.S. Cl. CPC H04W 4/023; H04L 5/0048; H04W 72/042; H04W 4/025

(57) ABSTRACT

Example methods, apparatuses, and/or articles of manufacture are disclosed herein that may be utilized, in whole or in part, to facilitate and/or support one or more operations and/or techniques for enhancing positioning assistance data via a mobile device-specific carrier aggregation capability, such as for use in or with mobile communication devices, for example.

### BACKGROUND

### 1. Field

The present disclosure relates generally to position or location estimations of mobile communication devices and, more particularly, to enhancing positioning assistance data via a mobile device-specific carrier aggregation capability for use in or with mobile communication devices.

### 2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance parameters obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless or electronic communications network. Acquired wireless signals may, for example, be processed by or at a mobile communication device, and its location may be estimated using known techniques, such as Advanced Forward Link Trilateration (AFLT), base station identification, cell tower triangulation, or the like.

In an indoor or like environment, such as urban canyons, for example, mobile communication devices may be unable to reliably receive or acquire satellite or like wireless signals to facilitate and/or support one or more position estimation techniques. For example, signals from an SPS or other wireless transmitters may be attenuated or otherwise affected in some manner (e.g., insufficient, weak, fragmentary, etc.), which may at least partially preclude their use for position estimations. At times, a mobile communication device may obtain a position fix by measuring ranges to three or more terrestrial wireless transmitter devices, such as cellular base stations, access points, etc. positioned at known locations. Ranges may be measured, for example, by obtaining a Media Access Control identifier (MAC ID) address from wireless signals received from suitable access points and measuring one or more characteristics of received signals, such as signal strength, round trip delay, or the like.

In some instances, a position fix of a mobile communication device may be obtained in connection with an observed time difference of arrival (OTDOA) technique. In this technique, a mobile communication device may measure timing differences between reference signals received from two or more pairs of cellular base stations, for example, and may obtain a position fix based, at least in part, on known locations and transmission timing for the measured base stations. An OTDOA positioning technique may, for example, be employed, in whole or in part, for purposes of traveling, navigation, direction finding, social media applications, or like services. OTDOA positioning technique may also be employed to assist in localization of a mobile communication device in the event of an emergency call, such as in compliance with Emergency 911 (E911) mandates from the Federal Communication Commission (FCC). At times, however, OTDOA positioning accuracy may be affected, at least in part, by search parameters that may be provided to a mobile communication device via positioning assistance data, such as to facilitate and/or support appropriate measurements (e.g., reference signal time differences, etc.), for example. In some instances, standard or typical search parameters may not be applicable to a number of mobile communication devices and/or cellular base stations, which may result in an increase of cellular data usage, associated costs and/or data charges, longer time-to-first-fix (TTFF), power consumption, etc. of mobile communication devices.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a message flow diagram illustrating an implementation of an example message exchange process for enhancing positioning assistance data via a mobile device-specific carrier aggregation capability.

FIG. 3 is a flow diagram illustrating an implementation of an example process for enhancing positioning assistance data via a mobile device-specific carrier aggregation capability.

FIG. 4 is a flow diagram illustrating another implementation of an example process for enhancing positioning assistance data via a mobile device-specific carrier aggregation capability.

FIG. 5 is a schematic diagram illustrating an implementation of an example computing environment associated with a mobile device.

FIG. 6 is a schematic diagram illustrating an implementation of an example computing environment associated with a server.

### SUMMARY

Example implementations relate to techniques for enhancing positioning assistance data via a mobile device-specific carrier aggregation capability. In one implementation, a method may comprise transmitting one or more messages to a location server, the one or more transmitted messages comprising one or more parameters indicative of at least a multiple-band carrier aggregation capability of a mobile device; and receiving one or more messages from the location server, the one or more received messages comprising positioning assistance data determined based, at least in part, on the one or more parameters indicative of the multiple-band carrier aggregation capability of the mobile device.

In another implementation, an apparatus may comprise means for transmitting one or more messages to a location server, the one or more transmitted messages comprising one or more parameters indicative of at least a multiple-band carrier aggregation capability of a mobile device; and means for receiving one or more messages from the location server, the one or more received messages comprising positioning assistance data determined based, at least in part, on the one or more parameters indicative of the multiple-band carrier aggregation capability of the mobile device.

In yet another implementation, an apparatus may comprise a communication interface coupled to a receiver of a mobile device to communicate with an electronic communications network and one or more processors coupled to a memory and to the communication interface, the communication interface and the one or more processors configured to transmit, via the electronic communications network, one or more messages to a location server, the one or more transmitted messages comprising one or more parameters indicative of at least a multiple-band carrier aggregation capability of the mobile device; and receive one or more messages from the location server, the one or more received messages comprising positioning assistance data determined based, at least in part, on the one or more parameters indicative of the multiple-band carrier aggregation capability of the mobile device.

In yet another implementation, an article may comprise a non-transitory storage medium having instructions executable by a processor to transmit one or more messages to a location server, the one or more transmitted messages comprising one or more parameters indicative of at least a multiple-band carrier aggregation capability of a mobile device; and receive one or more messages from the location server, the one or more received messages comprising positioning assistance data determined based, at least in part, on the one or more parameters indicative of the multiple-band carrier aggregation capability of the mobile device.

In yet another one implementation, a method may comprise receiving one or more first messages comprising one or more parameters indicative of multiple-band capabilities of a mobile device; and transmitting one or more second messages to the mobile device comprising positioning assistance data determined based, at least in part, on the one or more parameters indicative of the multiple-band capabilities of the mobile device.

In yet another implementation, an apparatus may comprise means for receiving one or more first messages comprising one or more parameters indicative of multiple-band capabilities of a mobile device; and means for transmitting one or more second messages to the mobile device comprising positioning assistance data determined based, at least in part, on the one or more parameters indicative of the multiple-band capabilities of the mobile device.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate and/or support one or more operations and/or techniques for enhancing positioning assistance data via a mobile device-specific carrier aggregation capability. As will be seen, in some instances, positioning assistance data may comprise OTDOA assistance data, for example, and one or more techniques discussed herein may be implemented, in whole or in part, in connection with a Long Term Evolution (LTE) positioning protocol (LPP) positioning session. In this context, “LPP positioning session” refers to one or more procedures and/or protocols that may be used, in whole or in part, for positioning of one or more mobile communication devices in connection with a location server via an exchange of messages. For example, in some instances, messages may include one or more communication sequences regarding capability exchange and/or transfer, assistance data exchange and/or transfer, location information transfer, etc., or any combination thereof. As a way of illustration, at times, an LPP-type positioning session may include, for example, a session providing one or more extensions for OTDOA or like positioning, such as an LPPe positioning session, though claimed subject matter is not so limited. In some instances, an LTE positioning protocol annex (LPPa) or like protocol may also be used, at least in part, such as to facilitate and/or support data collection from one or more proximate or neighbor wireless transmitters in connection with OTDOA positioning, for example, as will also be seen. It should be noted that even though the discussion throughout the specification primarily references particular signals, protocols, and/or networks, such as, for example, positioning reference signals (PRS) for OTDOA in 4G Long Term Evolution (LTE), such as for ease of description, any other suitable signals, protocols, and/or networks, such as 1× signals for Advanced Forward Link Trilateration (AFLT) in Code Division Multiple Access (CDMA), enhanced Cell ID (E-CID), and/or Wi-Fi positioning (e.g., based on downlink signals according to IEEE 802.11x standards, etc.), positioning for short range nodes (SRNs), such as Bluetooth® Low Energy (BTLE) beacons, satellite positioning system (SPS) signals, or the like may also be utilized herein, in whole or in part, such as in a similar or like fashion and/or without deviating from the scope of claimed subject matter.

As used herein, “mobile device,” “mobile communication device,” “location-aware mobile device,” or like terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, radio heat map generation tools, automobiles, internet of things (IOT) devices, wearable technology devices (e.g., smart watches, fitness trackers, etc.), communication equipment (e.g., routers, etc.), or the like. It should be appreciated, however, that these are merely examples of mobile devices that may be used, at least in part, to implement one or more operations and/or techniques for enhancing positioning assistance data via a mobile device-specific carrier aggregation capability, and that claimed subject matter is not limited in this regard. It should also be noted that the terms “position” and “location” may be used interchangeably herein.

As alluded to previously, at times, a position fix of a mobile device, such as a cellular telephone, for example, may be obtained based, at least in part, on information gathered from various systems. One such system may comprise, for example, an OTDOA positioning system. In this system, a server may facilitate and/or support positioning of a mobile device by providing positioning assistance data as well as computing and/or verifying (e.g., if computed at a mobile device, etc.) a position fix using one or more specific signals, referred to as reference signals. Namely, a mobile device may, for example, measure a time difference between reference signals received from a reference wireless transmitter and one or more neighbor wireless transmitters positioned at known locations. In this context, a “wireless transmitter” refers to any suitable device capable of transmitting and/or receiving wireless signals, such as via an integrated or associated receiver and/or transmitter, for example. As a way of illustration, a wireless transmitter may comprise, for example, a cellular base station, wireless local area network (WLAN) access point, radio beacon, femtocell, picocell, or the like. A mobile device may then compute its position fix, such as using obtained measurements or, optionally or alternatively, may report these measurements to a suitable location server, such as, for example, an Enhanced Serving Mobile Location Center (E-SMLC), a Secure User Plane Location (SUPL) Location Platform (SLP), or the like. In turn, with knowledge of locations of measured wireless transmitters, an E-SMLC, SUPL, or like server may, for example, compute a position fix of a mobile device using measured time differences and relative transmission timing, such as via one or more appropriate multilateration techniques, and may communicate the computed position fix to a mobile device of interest.

As was also indicated, at times, one or more operations and/or techniques for enhancing positioning assistance data via a mobile device-specific carrier aggregation capability may also be implemented in connection with one or more other positioning approaches, such as those utilizing measurements of time differences of signals received from a number of wireless transmitters, for example. Thus, in some instances, one or more operations and/or techniques discussed herein may be utilized, at least in part, in connection with, for example, AFLT used for locating a mobile device on a CDMA2000 network, as defined by the 3rd Generation Partnership Project 2 (3GPP2). Similarly to OTDOA, AFLT positioning may, for example, make use of information for measured wireless transmitters to help a mobile device, such as via AFLT assistance data to acquire and/or measure applicable reference signals for purposes of computing a position fix based, at least in part, on these measurements. Depending on an implementation, information may include, for example, locations (e.g., coordinates, etc.), transmission characteristics (e.g., timing, power, signal content, signal characteristics, etc.) of measured wireless transmitters, such as referred to as an almanac, a base station almanac (BSA), almanac data or BSA data, etc. Thus, at times, observed time differences measured by a mobile device (e.g., in connection with OTDOA, AFLT, etc.) may, for example, be used, at least in part, in conjunction with a BSA for measured wireless transmitters to calculate a position fix of a mobile device, such as at or by a location server (e.g., an E-SMLC, SLP, etc.), mobile device, or any combination thereof.

Continuing with the above discussion, to facilitate and/or support one or more operations and/or techniques for enhancing positioning assistance data via a mobile device-specific carrier aggregation capability, one or more wireless transmitters on a network may broadcast a PRS that may be distinct from one or more PRS broadcasted by other nearby wireless transmitters due, at least in part, to a use of a different frequency, different encoding, different times of transmission, or the like. A mobile device may measure PRS transmitted by a reference wireless transmitter and a proximate or neighbor wireless transmitter and may obtain, for example, a time of arrival (TOA) and/or a reference signal time difference (RSTD) measurement. In this context, “RSTD” refers to one or more measurements indicative of a difference in time of arrival between a PRS transmitted by a measured wireless transmitter, referred to herein as a “neighbor wireless transmitter,” and a PRS transmitted by a reference wireless transmitter. A reference wireless transmitter may be selected by a location server (e.g., an E-SMLC, SLP, etc.), mobile device, or a combination thereof so as to provide good or otherwise sufficient signal strength observed at a receiver of the mobile device, such that a PRS can be more accurately and/or more quickly acquired and/or measured, such as without any special assistance from a serving network, for example.

At times, such as during an LTE Positioning Protocol (LPP) session, for example, a mobile device may be provided with positioning assistance data by a serving network (e.g., by a location server, etc.) to assist in a PRS acquisition and/or measurement, as was also indicated. For example, at times, a location server may provide to a mobile device of interest OTDOA assistance data listing one or more neighbor wireless transmitters capable of transmitting a PRS, which may include identities, center frequencies, etc. of wireless transmitters, one or more predicted RSTD values, such as expected RSTD and/or expected RSTD uncertainty values, or the like. Assistance data may also include, for example, an identity of a reference wireless transmitter, frequency for a reference PRS signal, reference PRS code sequence, reference PRS transmission times, or the like. In some instances, assistance data may also specify one or more Quality of Service (QoS) parameters, which may also be used, at least in part, in connection with searching a PRS and/or measuring RSTD. For example, in some instances, a QoS parameter may comprise a maximum response time for measuring TOA and/or providing RSTD measurements to a location server, which a mobile device and/or server may take into account, such as while implementing one or more OTDOA positioning operations.

A mobile device may then typically measure a PRS (e.g., a TOA for a PRS, etc.) for one or more neighbor wireless transmitters, such as by integrating a received signal at a neighbor wireless transmitter carrier frequency, for example, in accordance with provided assistance data (e.g., a PRS frequency, etc.) and a QoS parameter (e.g., a maximum response time, etc.). For example, based, at least in part, on received assistance data and/or a QoS parameter, a mobile device may be capable of determining a number of neighbor wireless transmitters to be searched (e.g., for acquisition of a PRS, etc.) in an effective and/or efficient manner, an order and/or duration of a particular PRS search, dynamic time frame for responding with RSTD measurements, whether greater accuracy or faster time-to-first fix (TTFF) is desired for an optimum or otherwise suitable position fix, or the like. Having measured PRS, a mobile device may perform RSTD measurements, such as utilizing provided assistance data, for example, and may report RSTD measurements to a location server, such as prior to expiration of a maximum response time specified by the server via a QoS parameter.

Currently, a typical approach for searching a PRS, such as via a positioning session using an LPP, as one example, may be less effective and/or efficient due, at least in part, to a relatively static set of 3GPP standards that are rather uniformly applied across a variety of applications and/or systems. For example, in a typical LPP positioning session, a location server may not be aware of carrier aggregation capabilities of participating mobile devices, such as whether carrier aggregation on these devices are currently enabled, being actively used, or the like. More specifically, according to 3GPP, a capability transfer-related message from a mobile device typically comprises frequency bands for which the mobile device supports RSTD measurements, meaning that carrier aggregation-supported frequency band combinations are not provided by a mobile device and/or not know by a location server. In this context, “multi-band carrier aggregation” or simply “carrier aggregation” refers to a process or technique for combining multiple carrier frequencies across available spectrum. A carrier aggregation capability of a mobile device may, for example, allow the mobile device to receive and/or transmit wireless data simultaneously over more than one carrier frequency (e.g., a primary cell frequency as well as a secondary cell frequency, etc.), such as in contiguous elements of a spectrum and/or in different bands. A mobile device with a carrier aggregation capability may, for example, obtain an OTDOA measurement based, at least in part, on PRS transmitted in different frequency bands, as will be seen. In some instances, this may, for example, improve network performance, support wider bandwidth, increase data transmission rates, reduce TTFF and/or power consumption of a mobile device, or the like, as was indicated.

Continuing further with the above discussion, in a typical LPP positioning session, such as without knowledge of a mobile device's carrier aggregation capability, for example, a location server may merely transmit generic OTDOA assistance data that may be based, at least in part, on supported frequency bands and a rough or “a priori” location of the mobile device. While, at times, OTDOA assistance data may be descriptive of multiple neighbor wireless transmitters covering different bands in a particular region, for example, in some instances, such assistance data may not applicable and, thus, useful for certain mobile devices, such as those capable of utilizing carrier aggregation-supported frequency band combinations. As such, these or like mobile devices may, for example, end up repeatedly measuring PRS from and/or performing RSTD measurements for the same neighbor wireless transmitters, which may needlessly drain battery power, waste associated computing and/or processing resources, or the like. Also, in some instances, such as if carrier aggregation capabilities of mobile devices are not taken into consideration, for example, part of OTDOA assistance data may be left unutilized due, at least in part, to a lack of a mobile device's tuning ability with respect to particular band combinations.

As a way of illustration, in some instances, wireless transmitters typically identified via OTDOA assistance data may comprise, for example, different E-UTRA Absolute Radio Frequency Channel Numbers (EARFCNs) within a particular area or region, different and/or multiple bands, etc. If a wireless carrier has additional wireless transmitters installed in that area or region, which may typically be the case, an associated BSA may have a relatively larger number of wireless transmitters with different and/or multiple bands, EARFCN combinations, or the like. Thus, at times, a location server may roughly select a number of neighbor wireless transmitters with higher level bands (E-UTRA) and/or supported frequency bands within a particular area or region, for example, and may provide generalized inter-frequency measurement data (e.g., as part of OTDOA assistance data, etc.) for that area or region. As such, despite its ability to listen to multiple channels simultaneously, a mobile device may refrain and/or be precluded from tuning to certain frequency bands and/or EARFCNs, for example, and may end up using frequency of its primary receiver chain. Again, at times, this may, for example, waste available network bandwidth, increase time to measure PRS and/or perform appropriate RSTD measurements, result in an increase in power consumption of the mobile device, or the like.

Furthermore, a location server, not being aware of a mobile device's carrier aggregation capability, may, for example, provide OTDOA assistance data for typical 3GPP inter-frequency measurements that require periodic requests for measurement gaps, which, again, may increase PRS acquisition and/or RSTD measurement times. In this context, a “measurement gap” refers to a time period during which no signal transmission and reception at a mobile device occurs. Typically, measurement gaps are implemented via a mobile device with a single radio frequency (RF) capability of a receiver, such as to monitor neighbor wireless transmitters on other frequencies than a serving wireless transmitter (e.g., inter-RAT GSM, 3G, etc.), perform inter-frequency measurements (e.g., RSTD, etc.), or the like. For example, since there is no signal transmission and reception during a measurement gap, a mobile device with a single RF capability may be capable of switching to a target cell frequency (e.g., a secondary cell frequency, etc.) so as to acquire a PRS and/or perform appropriate RSTD measurements, and then switching back to a current cell frequency (e.g., a serving cell frequency, etc.). Measurement gaps are generally known and need not be described here in greater detail. In some instances, periodic requests for measurement gaps (e.g., for non-carrier aggregation band combinations, etc.) may also negatively affect mobile device's TTFF. Thus, in some instances, a relatively static or uniform PRS search strategy in 3GPP may, for example, lead to less than sufficient position fixes, less than accurate TOA and/or RSTD measurements, or the like. Accordingly, it may be desirable to develop one or more methods, systems, and/or apparatuses that may enhance and/or improve a typical 3GPP approach for PRS searching and/or RSTD measuring, such as via accounting for a mobile device-specific carrier aggregation capability, for example.

Thus, as will be discussed in greater detail below, in an implementation, a mobile device may, for example, provide its current multi-band carrier aggregation capability to a location server, such as via one or more appropriate messages during a capability transfer process or procedure. For example, in some instances, a mobile device may provide its current carrier aggregation capability via a capability transfer or like information element or parameter in connection with an LPP or like (e.g., LPPe, etc.) message exchange, as will also be seen. Based, at least in part, on a provided carrier aggregation capability, a location server may, for example, be capable of determining a number of neighbor wireless transmitters more useful for acquisition of PRS, such as those with a higher probability of detection and/or use, facilitating and/or supporting faster TTFF, more accurate position fix, etc. As such, a location server may be capable of providing positioning assistance data with PRS or like search parameters more tailored to a carrier aggregation capability of a particular mobile device, thus, allowing for wider utilization of available receiver chains, for example.

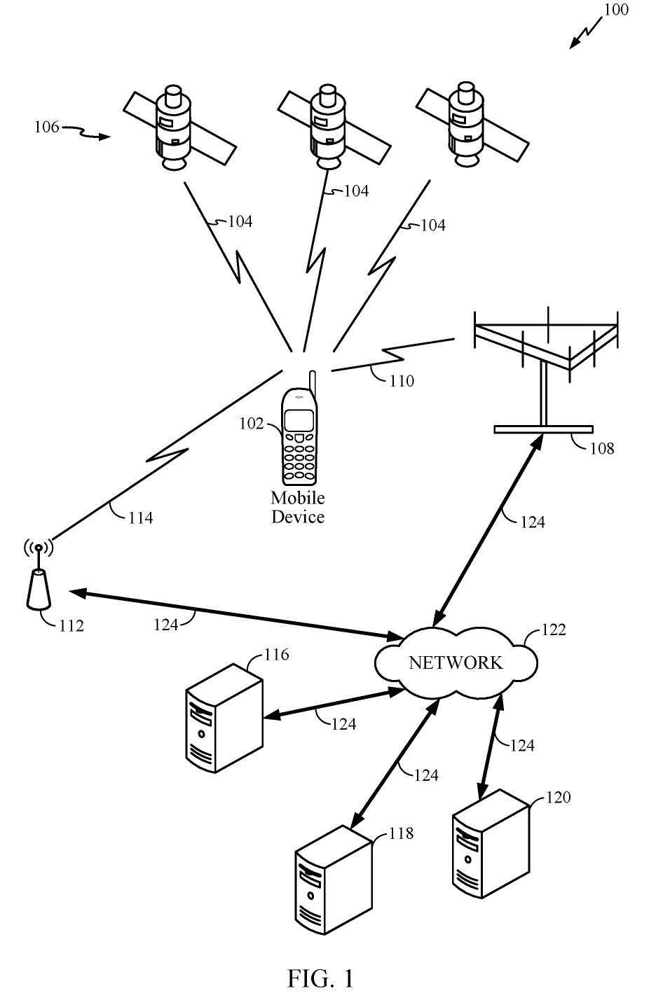

FIG. 1 is a schematic diagram illustrating features associated with an implementation of an example operating environment 100 capable of facilitating or supporting one or more processes and/or operations for enhancing positioning assistance data via a mobile device-specific carrier aggregation capability for use in or with a mobile device, such as a location-aware mobile device 102, for example. It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), WWAN, wireless local area networks (WLAN, etc.), or the like. It should also be noted that claimed subject matter is not limited to indoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an outdoor environment.

As illustrated, in an implementation, mobile device 102 may, for example, receive or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems. In certain implementations, SPS satellites 106 may be from any one several regional navigation satellite systems (RNSS) such as, for example, WAAS, EGNOS, QZSS, just to name a few examples.

At times, mobile device 102 may, for example, transmit wireless signals to, or receive wireless signals from, a suitable wireless communication network. In one example, mobile device 102 may communicate with a cellular communication network, such as by transmitting wireless signals to, or receiving wireless signals from, one or more wireless transmitters capable of transmitting and/or receiving wireless signals, such as a base station transceiver 108 over a wireless communication link 110, for example. Similarly, mobile device 102 may transmit wireless signals to, or receive wireless signals from a local transceiver 112 over a wireless communication link 114. Base station transceiver 108, local transceiver 112, etc. may be of the same or similar type, for example, or may represent different types of devices, such as access points (e.g., WLAN, etc.), radio beacons, cellular base stations, femtocells, or the like, depending on an implementation. Similarly, local transceiver 112 may comprise, for example, a wireless transmitter and/or receiver capable of transmitting and/or receiving wireless signals. For example, at times, wireless transceiver 112 may be capable of obtaining one or more signal-related observations, such as signals strength, time delay, etc. from one or more other terrestrial transmitters.

In a particular implementation, local transceiver 112 may be capable of communicating with mobile device 102 at a shorter range over wireless communication link 114 than at a range established via base station transceiver 108 over wireless communication link 110. For example, local transceiver 112 may be positioned in an indoor or like environment and may provide access to a wireless local area network (WLAN, e.g., IEEE Std. 802.11 network, etc.), wireless personal area network (WPAN, e.g., Bluetooth® network, etc.), or like local area networks. For example, in another example implementation, local transceiver 112 may comprise a femtocell or picocell capable of facilitating communication via link 114 according to an applicable cellular or like wireless communication protocol. Of course, it should be understood that these are merely examples of networks that may communicate with mobile device 102 over a wireless link, and claimed subject matter is not limited in this respect. For example, in some instances, operating environment 100 may include a larger number of base station transceivers 108, local transceivers 112, etc.

In an implementation, base station transceiver 108, local transceiver 112, etc. may communicate with servers 116, 118, or 120 over a network 122 via one or more links 124. Network 122 may comprise, for example, any combination of wired or wireless communication links. In a particular implementation, network 122 may comprise, for example, Internet Protocol (IP)-type infrastructure capable of facilitating or supporting communication between mobile device 102 and one or more servers 116, 118, 120, etc. via local transceiver 112, base station transceiver 108, etc. In another implementation, network 122 may comprise, for example cellular communication network infrastructure, such as a base station controller or master switching center to facilitate and/or support mobile cellular communication with mobile device 102. As was indicated, in some instances, network 122 may facilitate and/or support communications with a Public Safety Answering Point (PSAP) (not shown) or like entity, such as for purposes of initiating and/or implementing an E911 OTDOA positioning session, for example. Servers 116, 118, and/or 120 may comprise any suitable servers or combination thereof capable of facilitating or supporting one or more operations or techniques discussed herein. For example, servers 116, 118, and/or 120 may comprise one or more location servers (e.g., Evolved Serving Mobile Location Server (E-SMLC), Secure User Plane Location Server/SUPL Location Platform (SUPL SLP), etc.), positioning assistance servers, navigation servers, map servers, crowdsourcing servers, network-related servers, or the like.

In particular implementations, and as also discussed below, mobile device 102 may have circuitry or processing resources capable of determining a position fix or estimated location of mobile device 102, rough (e.g., “a priori”) or otherwise. For example, if satellite signals 104 are available, mobile device 102 may compute a position fix based, at least in part, on pseudorange measurements to four or more SPS satellites 106. Here, mobile device 102 may compute such pseudorange measurements based, at least in part, on pseudonoise code phase detections in signals 104 acquired from four or more SPS satellites 106. In particular implementations, mobile device 102 may receive from one or more servers 116, 118, or 120 positioning assistance data to aid in the acquisition of signals 104 transmitted by SPS satellites 106 including, for example, almanac, ephemeris data, Doppler search windows, just to name a few examples. If satellite signals 104 are not available, mobile device 102 may, for example, compute a position fix based, at least in part, on Cell ID, enhanced Cell ID, or like positioning. As discussed below, in some instances, mobile device 102 may, for example, compute a rough or “a priori” position fix based, at least in part, on one or more characteristics and/or aspects of local transceiver 112 obtained in connection with one or more positioning tiles, among other things.

In some implementations, mobile device 102 may obtain a position fix by processing wireless signals received from one or more terrestrial transmitters positioned at known locations (e.g., base station transceiver 108, local transceiver 112, etc.) using any one of several techniques, such as, for example, OTDOA, AFLT, or the like. In these techniques, a range from mobile device 102 may, for example, be measured to three or more of terrestrial transmitters based, at least in part, on one or more reference signals (e.g., PRS, etc.) transmitted by these transmitters and received at mobile device 102, as was indicated. Here, servers 116, 118, or 120 may be capable of providing positioning assistance data to mobile device 102 including, for example, OTDOA reference transmitter data, OTDOA neighbor transmitter data, PRS configuration data, RSTD search window, QoS parameters, locations, identities, orientations, etc. of terrestrial transmitters to facilitate and/or support one or more applicable positioning techniques (e.g., AFLT, OTDOA, etc.). At times, servers 116, 118, or 120 may include, for example, a base station almanac (BSA) indicating locations, identities, orientations, etc. of cellular base stations (e.g., base station transceiver 108, local transceiver 112, etc.) in one or more particular areas or regions associated with operating environment 100.

As alluded to previously, in particular environments, such as indoor or like environments (e.g., urban canyons, etc.), mobile device 102 may not be capable of acquiring or processing signals 104 from a sufficient number of SPS satellites 106 so as to perform a suitable positioning technique. Thus, optionally or alternatively, mobile device 102 may be capable of determining a position fix based, at least in part, on signals acquired from one or more local transmitters, such as femtocells, WLAN access points, or the like. For example, mobile device 102 may obtain a position fix by measuring ranges to three or more local transceivers 112 positioned at known locations. In some implementations, mobile device 102 may, for example, measure ranges by obtaining a MAC address from local transceiver 112, as was indicated.

In an implementation, mobile device 102 may, for example, receive positioning assistance data (e.g., OTDOA, AFLT assistance data, etc.) for one or more positioning operations from servers 116, 118, and/or 120. At times, positioning assistance data may include, for example, locations, identities, orientations, etc. of one or more local transceivers 112, base station transceivers 108, etc. positioned at known locations for measuring ranges to these transmitters based, at least in part, on an RTT, TOA, TDOA, etc., or any combination thereof. In some instances, positioning assistance data to aid indoor positioning operations may include, for example, radio heat maps, context parameter maps, routeability graphs, positioning tiles, etc., just to name a few examples. Other assistance data received by mobile device 102 may include, for example, electronic digital maps of indoor or like areas for display or to aid in navigation. A map may be provided to mobile device 102 as it enters a particular area, for example, and may show applicable features such as doors, hallways, entry ways, walls, etc., points of interest, such as bathrooms, pay phones, room names, stores, or the like. By obtaining a digital map of an indoor or like area of interest, mobile device 102 may, for example, be capable of overlaying its current location over the displayed map of the area so as to provide an associated user with additional context, frame of reference, or the like. The terms “positioning assistance data” and “navigation assistance data” may be used interchangeably herein.

According to an implementation, mobile device 102 may access navigation assistance data via servers 116, 118, and/or 120 by, for example, requesting such data through selection of a universal resource locator (URL). In particular implementations, servers 116, 118, and/or 120 may be capable of providing navigation assistance data to cover many different areas including, for example, floors of buildings, wings of hospitals, terminals at an airport, portions of a university campus, areas of a large shopping mall, etc., just to name a few examples. Also, if memory or data transmission resources at mobile device 102 make receipt of positioning assistance data for all areas served by servers 116, 118, and/or 120 impractical or infeasible, a request for such data from mobile device 102 may, for example, indicate a rough or course estimate of a location of mobile device 102. Mobile device 102 may then be provided navigation assistance data covering, for example, one or more areas including or proximate to a roughly estimated location of mobile device 102. In some instances, one or more servers 116, 118, and/or 120 may facilitate and/or support searching for PRS from one or more applicable wireless transmitters (e.g., local transceiver 112, base station transceiver 108, etc.) and/or performing RSTD or like measurements, such as for determining a position fix in connection with an E911 OTDOA positioning session, for example, and may provide the position fix to an applicable PSAP via network 122.

Even though a certain number of computing platforms and/or devices are illustrated herein, any number of suitable computing platforms and/or devices may be implemented to facilitate and/or support one or more techniques or processes associated with operating environment 100. For example, at times, network 122 may be coupled to one or more wired or wireless communication networks (e.g., WLAN, etc.) so as to enhance a coverage area for communications with mobile device 102, one or more base station transceivers 108, local transceiver 112, servers 116, 118, 120, or the like. In some instances, network 122 may facilitate and/or support femtocell-based operative regions of coverage, for example. Again, these are merely example implementations, and claimed subject matter is not limited in this regard.

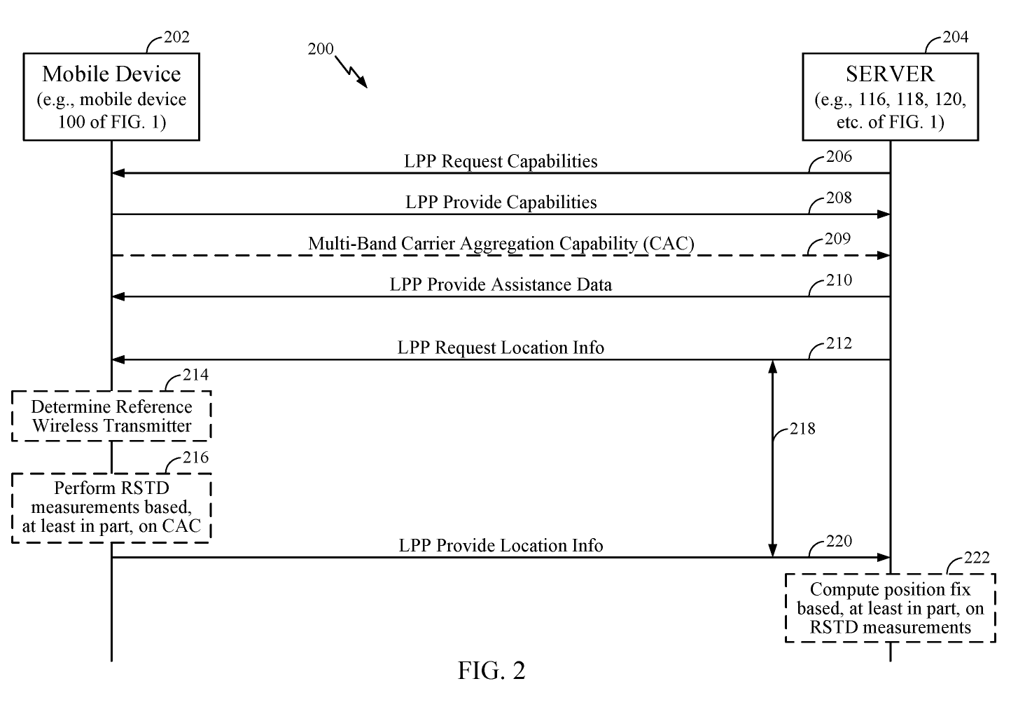

Referring now to FIG. 2, which is a message flow diagram illustrating an implementation of an example message exchange process 200 between a mobile device 202 and a server 204 that may facilitate and/or support one or more operations and/or techniques for enhancing positioning assistance data via a mobile device-specific carrier aggregation capability. As was indicated, even though process 200 illustrates OTDOA positioning using an LPP, claimed subject matter is not limited in this regard, and any other suitable positioning technique and/or protocol may be used herein, in whole or in part. For example, in some instances, an LPPe, LPP/LPPe, RRC protocol (e.g., as defined in 3GPP TS 36.331, etc.), IS-801 protocol (e.g., as defined in 3GPP2 TS C.S0022, etc.), or the like may also be employed herein, in whole or in part. At times, one or more operations and/or techniques for enhancing positioning assistance data via a mobile device-specific carrier aggregation capability may, for example, be implemented via OTDOA positioning for UMTS access, Enhanced Observed Time Difference (E-OTD) for GSM or AFLT, or the like. In addition, a downlink signal that is measured by mobile device 202 may not be a PRS, such as currently defined by 3GPP, but some other downlink reference signal or pilot signal (e.g., a common reference signal for LTE, etc.). Also, measurements of a downlink signal may not be of RSTD, such as also defined by 3GPP, for example, but instead of some other suitable quantity and/or phenomena, such as TOA, angle of arrival (AOA), received signal strength (e.g., RSSI), return trip time (RTT), signal-to-noise (S/N) ratio, or the like. Thus, although one or more applicable positioning techniques, protocols, measured quantities, etc. may differ, a search strategy with respect to acquisition of one or more downlink reference signals and/or pilot signals, such as via a mobile device-specific carrier aggregation capability, as discussed below, for example, may be the same as or similar to that described for process 200.

At times, process 200 may, for example, be implemented, at least in part, within operating environment 100 of FIG. 1. Thus, in some instances, mobile device 202 may comprise or be representative of mobile device 100 of FIG. 1, for example, and server 204 may comprise or be representative of server 116, 118, and/or 120 of FIG. 1, for example. In some instances, mobile device 202 may comprise, for example, a SUPL Enabled Terminal (SET), and server 204 may comprise, for example, a SUPL Location Platform (SLP), such as an H-SLP or D-SLP, just to illustrate one possible implementation. It should be noted that information acquired and/or produced, such as input signals, output signals, operations, results, messages, etc. associated with process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

As illustrated, positioning of mobile device 202 may be facilitated and/or supported via an exchange of LPP messages, as one possible example, between mobile device 202 and server 204 via any suitable communications network, such as network 122 of FIG. 1, for example, via one or more wireless transmitters, such as base station transceiver 108, local transceiver 112 of FIG. 1, etc., or a combination thereof. As will be seen, in some instances, process 200 may be used, at least in part, to eliminate or reduce RSTD measurement errors that may depend, at least in part, on one or more PRS search parameters, for example. As will also be seen, in some instances, process 200 may be used, at least in part, to obtain a relatively faster and/or more accurate TTFF of mobile device 202, such as if a carrier aggregation capability of a particular mobile device is known and/or being considered, for example. As was indicated, at times, process 200 may, for example, be used, at least in part, to obtain a location estimate of greater positioning accuracy than that which may be achieved via a current PRS search strategy in 3GPP, for example. Again, it should be noted that process 200 is not limited to indoor implementations. For example, at times, process 200 may be performed, at least in part, in an indoor-like environment, which may include partially or substantially enclosed areas, such as urban canyons, town squares, amphitheaters, parking garages, rooftop gardens, patios, or the like. In some instances, process 200 may, for example, be performed, at least in part, in an outdoor environment.

Thus, as illustrated, server 204 may, for example, transmit an LPP Request Capabilities message 206 to mobile device 202, such as indicating what types of capabilities are needed and/or supported by server 204 for an LPP positioning session. In turn, mobile device 202 may, for example, transmit an LPP Provide Capabilities message 208 providing its positioning capabilities to server 204, such as by specifying an OTDOA mode, frequency bands, inter-frequency RSTD measurements, etc. that are supported by mobile device 202. In some instances, LPP Provide Capabilities message 208 may also include, for example, a rough estimate of a location of mobile device 202, such as for purposes of providing expected RSTD values, uncertainty in expected RSTD values, or the like. Depending on an implementation, mobile device 202 may, for example, determine its rough location based, at least in part, on a location of a serving cellular base station, such as via Cell ID and/or enhanced Cell ID positioning, as one example, last known SPS position fix, dead reckoning using one or more appropriate sensors, upon request, or the like.

As referenced via a dashed arrow at 209, in some instances, mobile device 202 may transmit a message comprising, for example, a multi-band carrier aggregation capability (CAC) of mobile device 202, as was indicated. Depending on an implementation, a Multi-Band Carrier Aggregation Capability message 209 may include, for example, one or more information elements or parameters indicating whether a carrier aggregation capability on mobile device 202 is currently supported and/or enabled, a type of a carrier aggregation capability (e.g., a full, partial, etc.), a number of bands and/or receivers available on mobile device 202 for particular downlink carrier aggregation (DLCA) modes (e.g., 2DLCA, 3DLCA, etc.), types of supported carrier aggregation band combinations (e.g., 4A-17A, 1A-5A, 41A-41C, 1A-3A-5A, 3A-7A-40C, 4A-5A-12B, etc.), or the like, or any combination thereof. Depending on an implementation, a carrier aggregation capability of mobile device 202 may, for example, be supported on Intra-band contiguous and/or non-contiguous frequencies, as well as on Inter-band non-contiguous frequencies, as a few possible examples. In addition, a variety of Bandwidth class distributions, such as based, at least in part, on ATBC (Aggregated transmission bandwidth configuration) and/or maximum number of component carriers (CC) may, for example, be implemented herein. It should be noted that even though message 209 is illustrated as a separate communication, in some instances, one or more information elements or parameters with respect to a carrier aggregation capability of mobile device 202 may, for example, be included in LPP Provide Capabilities message 208 or any other suitable message (e.g., an Information Transfer message, etc.) or any suitable combination of messages associated with example message exchange process 200. Thus, message 209 may, for example, be optional in certain example implementations.

According to an implementation, having received LPP Provide Capabilities message 208 (e.g., with a carrier aggregation capability of mobile device 202, etc.) and/or Multi-Band Carrier Aggregation Capability message 209, server 204 may, for example, determine a number of neighbor wireless transmitters more useful for acquisition of PRS. For example, server 204 may select neighbor wireless transmitters with EARFCNs and/or band combinations matching a carrier aggregation capability of a receiver of mobile device 202. As a way of illustration, server 204 may, for example, select or determine a ratio or percentage of intra-frequency to inter-frequency neighbor wireless transmitters, such as based, at least in part, on carrier aggregation-supported bands, number of carrier aggregation receiver chains, EARFCN combination, etc. so that primary receiver chains as well as carrier aggregation receiver chains may be utilized, in whole or in part. In some instances, server 204 may intelligently partition OTDOA assistance data between intra-frequency and inter-frequency RSTD measurements with respect to particular neighbor wireless transmitters, for example, and may provide such data to mobile device 202, such as in separate neighbor wireless transmitter lists or in any suitable combination, as discussed below.

Thus, in an implementation, server 204 may transmit an LPP Provide Assistance Data message 210 to mobile device 202, such as comprising, for example, OTDOA assistance data for performing and/or returning RSTD measurements to server 204. As discussed above, OTDOA assistance data may be based, at least in part, on a carrier aggregation capability of mobile device 202 and may indicate that a particular wireless transmitter is to be used by mobile device 202 as a reference wireless transmitter, a number of neighbor wireless transmitters to measure, such as with separate references to intra-frequency and inter-frequency RSTD measurements (e.g., in separate neighbor lists, etc.), for example, may provide applicable PRS parameters, expected RSTD and/or expected RSTD uncertainty values, or the like. In some instances, LPP Provide Assistance Data message 210 may also include, for example, measured cell-specific reference signals (CRS) power levels for neighbor wireless transmitters, such as represented via a list or like data structure with corresponding reference signal received power (RSRP) values (e.g., in dBm, etc.). In this context, “RSRP” refers to a linear average over a power contribution of one or more reference signals, such as CRS, for example, observed at a receiver of mobile device 202 within a considered measurement frequency bandwidth. CRS and RSRP are generally known and need not be described here in greater detail. In some instances, RSRP values may, for example, be used, at least in part, by mobile device 202 to further prioritize an acquisition of PRS from stronger neighbor wireless transmitters.

In some instances, a neighbor list or like data structure in OTDOA positioning assistance data may comprise, for example, one or more reference signal received quality (RSRQ) values. In this context, “RSRQ” refers to an interference-type measure indicative of a quality of a received reference signal computed as RSRQ=(N*RSRP)/RSSI measured over the same bandwidth, where N is a number of resource blocks of a carrier RSSI measurement bandwidth. Likewise, RSRQ is generally known and need not be described here in greater detail. As such, similarly to RSRP, in some instances, such as in a shorter LPP-type positioning session, for example, mobile device 202 may reference provided RSRQ values of neighbor wireless transmitters and may select for acquisition of PRS transmitters with higher signal quality first, since wireless transmitters with higher RSRQ values may be presumed to be transmitting PRS that may be more quickly and/or accurately acquired. Thus, neighbor wireless transmitters with higher RSRQ values provided via a neighbor list may also be used, at least in part, or otherwise considered by mobile device 202 for the purpose of performing RSTD measurements, such as instead of or in addition to RSRP values, for example.

Server 204 may then send an LPP Request Location Information message 212 to mobile device 202 to request RSTD measurements for a reference wireless transmitter and up to seventy-two neighbor wireless transmitters, for example, if applicable. LPP Request Location Information message 212 may also comprise, for example, a desired accuracy of an OTDOA location estimate, expected multipath and/or non-line-of-sight (NLOS) conditions, and/or an optional periodic reporting period. In some instances, LPP Request Location Information message 212 may include, for example, a QoS parameter, such as indicating a timeframe for responding with RSTD measurements. As illustrated at 214, mobile device 202 may, for example, determine and/or make use of any indicated reference wireless transmitter. Mobile device 202 may, for example, base its determination, at least in part, on a signal level and/or signal quality (e.g. a S/N ratio, etc.) of one or more wireless transmitters indicated as being suitable (or not unsuitable) as a reference wireless transmitter. For example, at times, mobile device 202 may, for example, determine to use a wireless transmitter with a higher signal strength and/or higher S/N ratio, just to illustrate one possible implementation. Claimed subject matter is not so limited, of course. For example, in at least one implementation, mobile device 202 may employ a reference wireless transmitter specifically designated as such by server 204, which may be based, at least in part, on a carrier aggregation capability of mobile device 202, primary wireless transmitter EARFCN band, serving wireless transmitter, or the like. In this context, “serving wireless transmitter” refers to a primary wireless transmitter or a set of wireless transmitters comprising a primary wireless transmitter and one or more secondary wireless transmitters. Information regarding a carrier aggregation capability of mobile device 202 may, for example, be provided to server 204 via an appropriate serving wireless transmitter, such as via an LTE Positioning Protocol Annex (LPPa) or like protocol or procedure, just to illustrate one possible example.

As illustrated at 216, having determined a reference wireless transmitter, mobile device 202 may, for example, utilize, in whole or in part, obtained OTDOA assistance data to perform one or more RSTD measurements. For example, mobile device 202 may utilize one or more provided neighbor lists, such as tailored to its capability with respect to carrier aggregation band combinations, and may perform intra-frequency RSTD measurements and/or inter-frequency RSTD measurements, or any combination thereof. Since a carrier aggregation capability of mobile device 202 has been taken into consideration by server 204 while preparing and/or providing OTDOA assistance data, here, mobile device 202 may, for example, be capable of performing RSTD measurements on primary as well as secondary wireless transmitter frequencies and/or band combinations without requesting measurement gaps, as was indicated.

Depending on an implementation, mobile device 202 may also utilize, at least in part, a QoS parameter, such as a maximum response time for performing and/or replying with RSTD measurements to server 204, referenced generally at 218. A maximum response time may, for example, be specified via an integer number of seconds, as one example, such as measured between receipt of message 212 and an LPP Provide Location information message 220. Here, instead of searching for PRS in an order of priority that would typically be specified by server 204 via generic OTDOA assistance data, for example, mobile device 202 may omit or exclude from a PRS search wireless transmitters with un-tunable band combinations, among other incompatibilities, and may prioritize measuring more useful wireless transmitters, such as those with EARFCNs and/or band combinations matching its carrier aggregation capability. At times, this may, for example, improve positioning accuracy of mobile device 202, such as particularly in shorter LPP or like positioning sessions with a smaller QoS parameter. For shorter LPP-type positioning sessions, a maximum response time may typically be specified, such as by server 204, for example, via a lower integer number (e.g., 3, 4, 5, etc. seconds).

In at least one implementation, mobile device 202 may, for example, consider and/or account for measured power levels of CRS from one or more neighbor wireless transmitters, such as while measuring neighbor wireless transmitters based, at least in part, its carrier aggregation capability. For example, mobile device 202 may make use of RSRP and/or RSRQ values provided via assistance data and may select a group of neighbor wireless transmitters with higher RSRP and/or RSRQ values (e.g., overall, etc.), as one possible example, such as for candidate groups with similar wireless transmitter frequencies and/or band combinations. Claimed subject matter is not so limited, of course. Any other suitable approach may be used herein, in whole or in part, or otherwise considered. For example, at times, separate contributions of RSRP and/or RSRQ values from neighbor wireless transmitters may also be considered. Thus, here, mobile device 202 may, for example, search for PRS from wireless transmitters with a higher probability of detection first. As such, a larger number of neighbor wireless transmitters more useful for obtaining a more accurate position fix may, for example, be measured, such as, within a shorter timeframe specified via a QoS parameter.

Thus, according to an implementation, by measuring TOA for PRS from more useful neighbor wireless transmitters, rather than in a sorting order that would typically be specified via a generic OTDOA assistance data, a larger number of neighbor wireless transmitters more useful for obtaining more accurate RSTD measurements, for example, may be detected and/or measured, such as prior to expiration of maximum response time 218. In addition, at times, by determining which neighbor wireless transmitters may be more quickly and/or accurately measured, such as based, at least in part, on respective RSRP and/or RSRQ values in addition to a carrier aggregation capability, for example, a time to acquire PRS may be shortened, which may provide benefits for shorter LPP or like positioning sessions. Mobile device 202 may, thus, be capable of implementing more effective and/or more efficient PRS searches, such as in comparison to a current 3GPP PRS search strategy, such as by using more tailored OTDOA assistance data specifying which neighbor wireless transmitters to measure in order to avoid or reduce RSTD measurement errors.

In an implementation, mobile device 202 may then transmit LPP Provide Location Information message 220 to server 204, such as prior to or at expiration of maximum response time 218, for example, conveying RSTD measurements performed at 216. LPP Provide Location Information message 220 may also include times at which one or more RSTD measurements were obtained, for example, and an identity of a reference wireless transmitter for RSTD measurements (e.g. a reference Cell ID, carrier frequency, etc.). Message 220 may also include, for example, identities of measured neighbor wireless transmitters (e.g. a PCI, Global Cell ID, cell carrier frequency, etc.), quality of applicable measurements (e.g. an expected error in an RSTD measurement, etc.), etc. As further illustrated at 222, in an implementation, server 204 may, for example, compute a position fix of mobile device 202 based, at least in part, on transmitted RSTD measurements, such as via one or more appropriate positioning techniques (e.g., OTDOA, AFLT, etc.). In some instances, a position fix of mobile device 202 may, for example, be computed at or by mobile device 202, such as if assistance data provided via message 210 includes BSA for a reference and neighbor wireless transmitters (e.g., location coordinates, synchronization data, etc.). In such a case, mobile device 202 may, for example, provide its computed location estimate to server 204 via message 220.

In some instances, such as in certain server-supported implementations, for example, a serving wireless transmitter (e.g., eNodeB, etc.) may have knowledge from appropriate network resources and/or communications with respect to a carrier aggregation capability of mobile device 202. For example, a serving wireless transmitter may know whether a carrier aggregation capability on mobile device 202 is currently enabled, a type of a carrier aggregation capability (e.g., a full, partial, etc.), a number of bands and/or receivers available on mobile device 202 for particular downlink carrier aggregation (DLCA) modes (e.g., 2DLCA, 3DLCA, etc.), types of supported carrier aggregation band combinations (e.g., 4A-17A, 1A-5A, 4A-13A, 4A-12A, 2A-4A, etc.), or the like, or any combination thereof. Thus, at times, a serving wireless transmitter may, for example, communicate this or like information to server 204 via an appropriate message and/or protocol. For example, in some instances, a serving wireless transmitter may utilize, in whole or in part, an LTE Positioning Protocol Annex (LPPa) protocol, such as while mobile device 202 is in a Radio Resource Control (RRC) connected mode (e.g., RRC_CONNECTED, etc.), for example, just to illustrate one possible implementation. In turn, server 204 may use this or like information to enhance OTDOA assistance data, such as by tailoring PRS search parameters to a particular carrier aggregation capability of mobile device 202 in a similar fashion.

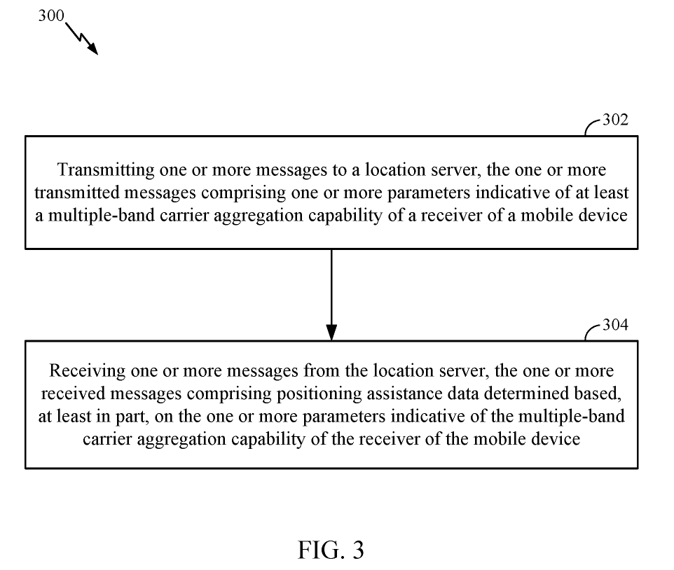

With this in mind, attention is now drawn to FIG. 3, which is a flow diagram illustrating an implementation of an example process 300 that may be performed, in whole or in part, to facilitate and/or support one or more operations and/or techniques for enhancing positioning assistance data (e.g., OTDOA, LTE, etc.) via a mobile device-specific carrier aggregation capability for use in or with a location-aware mobile device, such as mobile device 102 of FIG. 1 and/or mobile device 202 of FIG. 2, for example. It should be noted that information acquired or produced, such as, for example, input signals, output signals, operations, results, etc. associated with example process 300 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 300 may, for example, begin at operation 302 with transmitting one or more messages to a location server, the one or more transmitted messages comprising one or more parameters indicative of at least a multiple-band carrier aggregation capability of a receiver of a mobile device. As was indicated, these one or more parameters may, for example, be transmitted via any suitable message including, for example, a capability transfer message transmitted via an LPP or like protocol (e.g., LPPe, etc.), such as an LPP Provide Capabilities message (e.g., message 208 of FIG. 2, etc.), a Multi-Band Carrier Aggregation Capability message (e.g., message 209 of FIG. 2, etc.), or the like, or any combination thereof. Depending on an implementation, one or more transmitted parameters may include, for example, one or more information elements indicating whether a carrier aggregation capability on a mobile device is currently supported and/or enabled, a type of a carrier aggregation capability (e.g., a full, partial, etc.), a number of bands and/or receivers available on a mobile device for particular downlink carrier aggregation (DLCA) modes (e.g., 2DLCA, 3DLCA, etc.), types of supported carrier aggregation band combinations (e.g., 4A-17A, 1A-5A, 4A-13A, 4A-12A, 2A-4A, etc.), or the like, or any combination thereof. As was also discussed, a multiple-band carrier aggregation capability of a mobile device may comprise, for example, a capability of an associated receiver to combine multiple carrier frequencies across available radio spectrum. Thus, in some instances, a receiver on a mobile device may comprise, for example, a plurality of receivers capable of receiving and/or transmitting wireless data simultaneously over more than one carrier frequency, such as in contiguous elements of the available radio spectrum and/or in different frequency bands.

As was also discussed, having received one or more messages (e.g., with a carrier aggregation capability of a mobile device, etc.), a location server may, for example, determine a number of neighbor wireless transmitters more useful for acquisition of PRS. For example, a location server may select neighbor wireless transmitters with EARFCNs and/or band combinations matching a carrier aggregation capability (e.g., of a receiver, etc.) of a particular mobile device. At times, a location server may, for example, select or determine a ratio or percentage of intra-frequency to inter-frequency neighbor wireless transmitters based, at least in part, on carrier aggregation-supported bands, number of carrier aggregation receiver chains, EARFCN combination, etc. In some instances, this may, for example, facilitate and/or support utilization of one or more primary receiver chains as well as carrier aggregation receiver chains, in whole or in part. In some instances, a location server may intelligently partition OTDOA assistance data between intra-frequency and inter-frequency RSTD measurements with respect to particular neighbor wireless transmitters, for example, for inclusion in neighbor wireless transmitter lists (e.g., separate, etc.), just to illustrate one possible implementation.

With regard to operation 304, one or more messages may, for example, be received from the location server, the one or more received messages comprising positioning assistance data determined based, at least in part, on the one or more parameters indicative of the multiple-band carrier aggregation capability of the receiver of the mobile device. As was indicated, depending on an implementation, positioning assistance data may comprise, for example, OTDOA, AFLT, or like assistance data for performing and/or returning RSTD measurements. Positioning assistance data may, for example, indicate that a particular wireless transmitter is to be used as a reference wireless transmitter, a number of neighbor wireless transmitters to measure (e.g., for intra-frequency and/or inter-frequency RSTD measurements, etc.), may provide applicable PRS parameters, expected RSTD and/or expected RSTD uncertainty values, measured power levels of one or more downlink reference signals, or the like. A mobile device may, for example, utilize, in whole or in part, obtained positioning assistance data to perform one or more RSTD measurements, such as based, at least in part, on its multiple-band carrier aggregation capability, as discussed above. At times, this may, for example, facilitate and/or support relatively faster and/or more accurate TTFF of a mobile device, improve its power consumption, help with OTDOA or like positioning, etc., as also discussed herein. Likewise, here, having acquired appropriate PRS, a mobile device may, for example, perform one or more applicable measurements (e.g., RSTD measurements, etc.) in a more effective and/or more efficient manner and may communicate these measurements to a location server via a suitable message (e.g., message 220 of FIG. 2, etc.), such as for computation of a position fix.

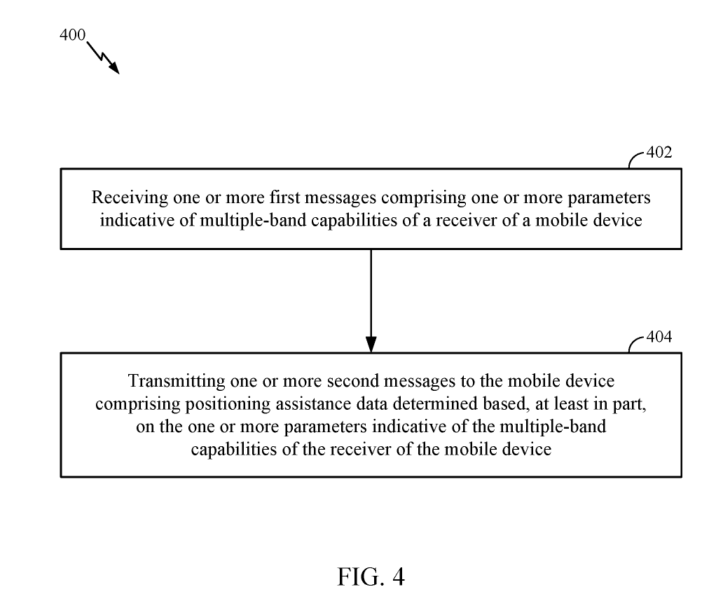

FIG. 4 is a flow diagram illustrating an implementation of another example process, referenced herein at 400, that may be performed, in whole or in part, to facilitate and/or support one or more operations and/or techniques for enhancing positioning assistance data via a mobile device-specific carrier aggregation capability for use in or with a location-aware mobile device, such as mobile device 102 of FIG. 1 and/or mobile device 202 of FIG. 2, for example. Likewise, it should be noted that information acquired or produced, such as, for example, input signals, output signals, operations, results, etc. associated with example process 400 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 400 may begin at operation 402 with receiving one or more first messages comprising, for example, one or more parameters indicative of multiple-band capabilities of a receiver of a mobile device. Likewise, here, one or more parameters may comprise, for example, one or more information elements indicating whether a carrier aggregation capability on a mobile device is currently supported and/or enabled, a type of a carrier aggregation capability (e.g., a full, partial, etc.), a number of bands and/or receivers available on a mobile device for particular downlink carrier aggregation (DLCA) modes (e.g., 2DLCA, 3DLCA, etc.), types of supported carrier aggregation band combinations (e.g., 4A-17A, 1A-5A, 4A-13A, 4A-12A, 2A-4A, etc.), or the like, or any combination thereof. Depending on an implementation, one or more first messages may, for example, be transmitted by and/or received from any suitable computing and/or communication device. For example, in some instances, one or more messages may be transmitted by and/or received from a mobile device, such as providing details with respect to its carrier aggregation capability via an applicable capability transfer procedure (e.g., an LPP, LPPe, etc.).

At times, one or more messages may, for example, be transmitted by and/or received from a wireless transmitter currently serving a mobile device. For example, as was indicated, for a mobile device in an RRC_CONNECTED mode and without a carrier aggregation capability, there may be just one serving wireless transmitter comprising of a primary wireless transmitter. In some instances, such as for a mobile device in an RRC_CONNECTED mode and with a carrier aggregation capability (e.g., mobile device 202 of FIG. 2, etc.), for example, a serving wireless transmitter may comprise a set of transmitters comprising of a primary wireless transmitter and one or more secondary wireless transmitters. Thus, at times, one or more parameters indicative of multiple-band capabilities of a receiver of a mobile device may, for example, be transmitted by and/or received from a neighbor wireless transmitter via LPPa or like assistance data, as was indicated. By way of example but not limitation, LPPa assistance data may, for example, be transmitted from an eNodeB and received by an E-SMLC to facilitate and/or support OTDOA positioning in accordance with 3GPP's technical specification TS 36.455. Claimed subject matter is not so limited, of course.

Similarly, here, having received one or more first messages (e.g., with a carrier aggregation capability of a mobile device, etc.), a location server may, for example, determine a number of neighbor wireless transmitters more useful for acquisition of PRS. For example, a location server may select neighbor wireless transmitters with EARFCNs and/or band combinations matching a carrier aggregation capability (e.g., of a receiver, etc.) of a mobile device. A location server may, for example, select or determine a ratio or percentage of intra-frequency to inter-frequency neighbor wireless transmitters based, at least in part, on a carrier aggregation-supported bands, number of carrier aggregation receiver chains, EARFCN combination, etc. so that primary as well as carrier aggregation receiver chains may be utilized, in whole or in part. A location server may, for example, this or like information to enhance positioning assistance data, as was also discussed. In some instances, a location server may intelligently partition assistance data between intra-frequency and inter-frequency RSTD measurements with respect to particular neighbor wireless transmitters, for example, and may provide such data to a mobile device in one or more appropriate neighbor lists.

With regard to operation 404, one or more second messages may, for example, be transmitted to the mobile device, the one or more second messages comprising positioning assistance data determined based, at least in part, on the one or more parameters indicative of the multiple-band capabilities of the receiver of the mobile device. Likewise, one or more second messages may be transmitted via any suitable protocol or procedure and may include, for example, OTDOA assistance data, LTE assistance data, or the like. A mobile device may, for example, utilize, in whole or in part, obtained positioning assistance data to perform one or more RSTD measurements, such as based, at least in part, on its carrier aggregation capability. For example, a mobile device may utilize one or more provided neighbor lists (e.g., separate, etc.), such as tailored to its receiver capabilities with respect to carrier aggregation band combinations, and may perform intra-frequency RSTD measurements and/or inter-frequency RSTD measurements, or any combination thereof, in a suitable manner. Since a carrier aggregation capability of a mobile device has been taken into consideration while preparing and/or providing positioning assistance data, a mobile device may, for example, be capable of performing RSTD measurements on primary as well as secondary wireless transmitter frequencies and/or band combinations, such as without requesting measurement gaps, as was also indicated.

Accordingly, as discussed herein, one or more operations and/or techniques for enhancing positioning assistance data via a mobile device-specific carrier aggregation capability may provide benefits. For example, since particular receiver chains may be utilized more effectively and/or more efficiently, at times, a total number of RSTD measurements sufficient for a more accurate position fix may, for example, be reduced. In turn, a smaller number of requisite RSTD measurements may, for example, lead to a shorter TTFF, as was indicated. In addition, in some instances, due, at least in part, to availability of multi-frequency channels or so-called “frequency diversity,” harmful environmental effects of radio propagation, such as multipath, shadow fading, etc. may, for example, be eliminated or reduced, which, in turn, may eliminate or reduce biased RSTD measurements and result in more accurate position determination. As was also discussed, in some instances, OTDOA assistance data with receiver-compatible intra-frequency and/or inter-frequency band combinations may eliminate or reduce requests for measurement gaps, for example, which may improve power consumption and/or usability of a mobile device and/or particular wireless carrier. At times, this may also provide market incentives for selecting a particular wireless carrier and/or mobile device over others. Of course, such a description of certain aspects of enhancing OTDOA assistance data via a mobile device-specific carrier aggregation capability and its benefits is merely an example, and claimed subject matter is not so limited.

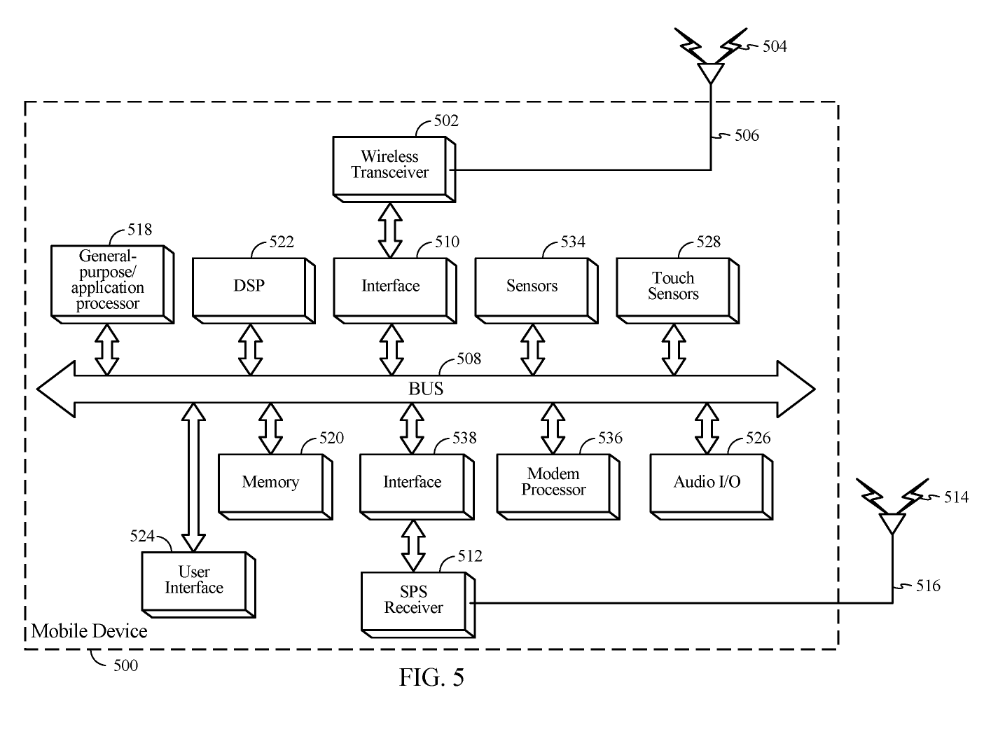

FIG. 5 is a schematic diagram of an implementation of an example computing environment associated with a mobile device that may be used, at least in part, to facilitate and/or support one or more operations and/or techniques for enhancing positioning assistance data via a mobile device-specific carrier aggregation capability. An example computing environment may comprise, for example, a mobile device 500 that may include one or more features or aspects of mobile device 102 of FIG. 1 and/or mobile device 202 of FIG. 2, though claimed subject matter is not so limited. For example, in some instances, mobile device 500 may comprise a wireless transceiver 502 capable of transmitting and/or receiving wireless signals, referenced generally at 504, such as via an antenna 506 over a suitable wireless communications network. Wireless transceiver 502 may, for example, be capable of sending or receiving one or more suitable communications, such as one or more communications discussed with reference to FIGS. 1-4. Wireless transceiver 502 may, for example, be coupled or connected to a bus 508 via a wireless transceiver bus interface 510. Depending on an implementation, at times, wireless transceiver bus interface 510 may, for example, be at least partially integrated with wireless transceiver 502. Some implementations may include multiple wireless transceivers 502 or antennas 506 so as to enable transmitting or receiving signals according to a corresponding multiple wireless communication standards such as WLAN or WiFi, Code Division Multiple Access (CDMA), Wideband-CDMA (W-CDMA), Long Term Evolution (LTE), Bluetooth®, just to name a few examples.

In an implementation, mobile device 500 may, for example, comprise an SPS or like receiver 512 capable of receiving or acquiring one or more SPS or other suitable wireless signals 514, such as via an SPS or like antenna 516. SPS receiver 512 may process, in whole or in part, one or more acquired SPS signals 514 for estimating a location of mobile device 500, rough or otherwise. In some instances, one or more general-purpose/application processors 518 (henceforth referred to as “processor”), memory 520, digital signal processor(s) (DSP) 522, or like specialized devices or processors not shown may be utilized to process acquired SPS signals 514, in whole or in part, calculate a location of mobile device 500, such as in conjunction with SPS receiver 512, or the like. Storage of SPS or other signals for implementing one or more positioning operations, such as in connection with one or more operations and/or techniques for improving OTDOA positioning via one or more local wireless transmitters, for example, may be performed, at least in part, in memory 520, suitable registers and/or buffers (not shown). Although not shown, it should be appreciated that in at least one implementation one or more processors 518, memory 520, DSPs 522, or like specialized devices or processors may comprise one or more processing modules capable of transmitting one or more messages to a location server, the one or more transmitted messages comprising one or more parameters indicative of at least a multiple-band carrier aggregation capability of a receiver of mobile device 500; and receiving one or more messages from the location server, the one or more received messages comprising positioning assistance data determined based, at least in part, on the one or more parameters indicative of the multiple-band carrier aggregation capability of the receiver of mobile device 500.

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 518 or DSP 522 may include one or more processors, controllers, microprocessors, microcontrollers, application specific integrated circuits, digital signal processors, programmable logic devices, field programmable gate arrays, central processing units, graphics processor units, or the like, or any combination thereof. Thus, at times, processor 518 or DSP 522 or any combination thereof may comprise or be representative of means for transmitting one or more messages to a location server, the one or more transmitted messages comprising one or more parameters indicative of at least a multiple-band carrier aggregation capability of a receiver of mobile device 500, such as to implement operation 302 of FIG. 3, at least in part. In addition, in at least one implementation, processor 518 or DSP 522 may be representative of or comprise, for example, means for receiving one or more messages from the location server, the one or more received messages comprising positioning assistance data determined based, at least in part, on the one or more parameters indicative of the multiple-band carrier aggregation capability of the receiver of mobile device 500, such as to implement operation 304 of FIG. 3, at least in part.

As illustrated, DSP 522 may be coupled or connected to processor 518 and memory 520 via bus 508. Although not shown, in some instances, bus 508 may comprise one or more bus interfaces that may be integrated with one or more applicable components of mobile device 500, such as DSP 522, processor 518, memory 520, or the like. In various embodiments, one or more operations or functions described herein may be performed in response to execution of one or more machine-readable instructions stored in memory 520, such as on a computer-readable storage medium, such as RAM, ROM, FLASH, disc drive, etc., just to name a few examples. Instructions may, for example, be executable via processor 518, one or more specialized processors not shown, DSP 522, or the like. Memory 520 may comprise a non-transitory processor-readable memory, computer-readable memory, etc. that may store software code (e.g., programming code, instructions, etc.) that may be executable by processor 518, DSP 522, or the like to perform operations or functions described herein.

Mobile device 500 may comprise a user interface 524, which may include any one of several devices such as, for example, a speaker, microphone, display device, vibration device, keyboard, touch screen, etc., just to name a few examples. In at least one implementation, user interface 524 may enable a user to interact with one or more applications hosted on mobile device 500. For example, one or more devices of user interface 524 may store analog or digital signals on memory 520 to be further processed by DSP 522, processor 518, etc. in response to input or action from a user. Similarly, one or more applications hosted on mobile device 500 may store analog or digital signals in memory 520 to present an output signal to a user. In some implementations, mobile device 500 may optionally include a dedicated audio input/output (I/O) device 526 comprising, for example, a dedicated speaker, microphone, digital to analog circuitry, analog to digital circuitry, amplifiers, gain control, or the like. It should be understood, however, that this is merely an example of how audio I/O device 526 may be implemented, and that claimed subject matter is not limited in this respect. As seen, mobile device 500 may comprise one or more touch sensors 528 responsive to touching or like pressure applied on a keyboard, touch screen, or the like.

Mobile device 500 may comprise one or more sensors 534 coupled or connected to bus 508, such as, for example, one or more inertial sensors, ambient environment sensors, or the like. Inertial sensors of sensors 544 may comprise, for example, one or more accelerometers (e.g., collectively responding to acceleration of mobile device 500 in one, two, or three dimensions, etc.), gyroscopes or magnetometers (e.g., to support one or more compass or like applications, etc.), etc., just to illustrate a few examples. Ambient environment sensors of mobile device 500 may comprise, for example, one or more barometric pressure sensors, temperature sensors, ambient light detectors, camera sensors, microphones, etc., just to name few examples. Sensors 534 may generate analog or digital signals that may be stored in memory 520 and may be processed by DSP 522, processor 518, etc., such as in support of one or more applications directed to positioning or navigation operations, wireless communications, radio heat map learning, video gaming or the like.

In a particular implementation, mobile device 500 may comprise, for example, a modem processor 536, dedicated or otherwise, capable of performing baseband processing of signals received or downconverted via wireless transceiver 502, SPS receiver 512, or the like. Similarly, modem processor 536 may perform baseband processing of signals to be upconverted for transmission via wireless transceiver 502, for example. In alternative implementations, instead of having a dedicated modem processor, baseband processing may be performed, at least in part, by processor 518, DSP 522, or the like. In addition, in some instances, an interface 538, although illustrated as a separate component, may be integrated, in whole or in part, with one or more applicable components of mobile device 500, such as bus 508 or SPS receiver 512, for example. Optionally or alternatively, SPS receiver 512 may be coupled or connected to bus 508 directly. It should be understood, however, that these are merely examples of components or structures that may perform baseband processing, and that claimed subject matter is not limited in this regard.

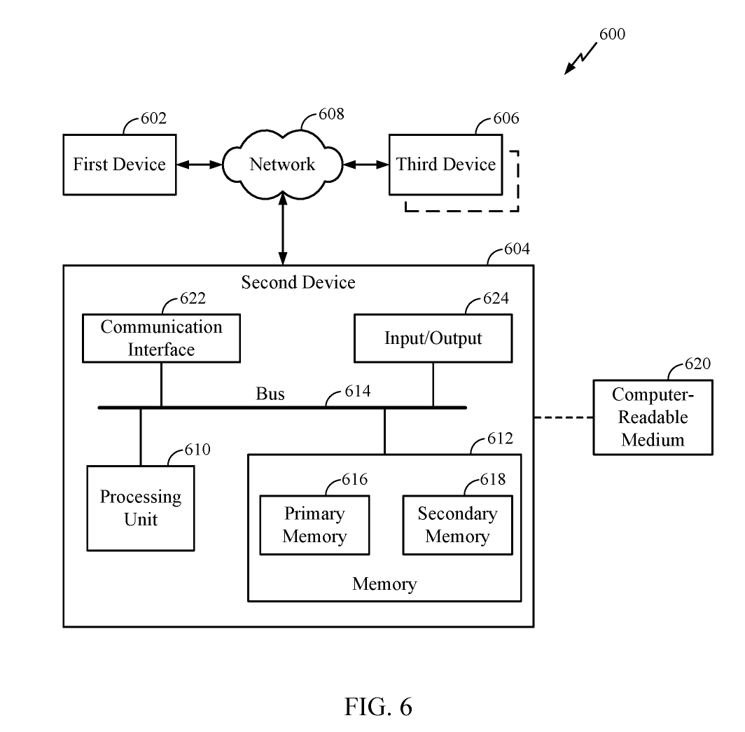

FIG. 6 is a schematic diagram illustrating an implementation of an example computing environment or system 600 that may be associated with and/or include one or more servers and/or other devices capable of partially and/or substantially implementing and/or supporting one or more operations and/or techniques for enhancing positioning assistance data via a mobile device-specific carrier aggregation capability, such as discussed above in connection with FIGS. 1-5, for example. Computing environment 600 may include, for example, a first device 602, a second device 604, a third device 606, etc., which may be operatively coupled together via a communications network 608. In some instances, first device 602 may comprise a location server capable of providing positioning assistance data and/or associated parameters, such as, for example, identities, locations, etc. of wireless transmitters, radio heat map, base station almanac, database of wireless transmitters, bias estimates, signal measurements, reference transmitter parameters, neighbor transmitter parameters, positioning tiles, neighbor lists, or the like, such as discussed herein. For example, first device 602 may also comprise a server capable of providing an electronic digital map to a mobile device based, at least in part, on a priori or rough estimate of a location of the mobile device (e.g., determined via last known SPS position fix, dead reckoning using one or more appropriate sensors, Cell ID, enhanced Cell ID, positioning tiles, etc.), upon request, or the like. First device 602 may also comprise a server capable of providing any other suitable positioning assistance data (e.g., a radio heat map, positioning tiles, etc.) relevant to a location of a mobile device. Second device 604 or third device 606 may comprise, for example, mobile devices, though claimed subject matter is not so limited. For example, in some instances, second device 604 may comprise a server functionally or structurally similar to first device 602, just to illustrate another possible implementation. In addition, communications network 608 may comprise, for example, one or more wireless transmitters, such as cellular base stations, Wi-Fi access points, femtocells, or the like. Of course, claimed subject matter is not limited in scope in these respects.

First device 602, second device 604, or third device 606 may be representative of any device, appliance, platform, or machine that may be capable of exchanging parameters and/or information over communications network 608. By way of example but not limitation, any of first device 602, second device 604, or third device 606 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 602, 604, and 606, respectively, may comprise one or more of a mobile device, wireless transmitter or receiver, server, etc. in accordance with example implementations described herein.

In an implementation, communications network 608 may be representative of one or more communication links, processes, or resources capable of supporting an exchange of information between at least two of first device 602, second device 604, or third device 606. By way of example but not limitation, communications network 608 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 606, there may be additional like devices operatively coupled to communications network 608. It is also recognized that all or part of various devices or networks shown in computing environment 600, or processes or methods, as described herein, may be implemented using or otherwise including hardware, firmware, software, or any combination thereof.

By way of example but not limitation, second device 604 may include at least one processing unit 610 that may be operatively coupled to a memory 612 via a bus 614. Processing unit 610 may be representative of one or more circuits capable of performing at least a portion of a suitable computing procedure or process. For example, processing unit 610 may include one or more processors, controllers, microprocessors, microcontrollers, application specific integrated circuits, digital signal processors, programmable logic devices, field programmable gate arrays, or the like, or any combination thereof. Although not shown, second device 604 may include a location-tracking unit that may initiate a position fix of a suitable mobile device, such as in an area of interest, for example, based, at least in part, on one or more received or acquired wireless signals, such as from an SPS, one or more cellular base stations, Wi-Fi access points, etc. In some implementations, a location-tracking unit may be at least partially integrated with a suitable processing unit, such as processing unit 610, for example, though claimed subject matter is not so limited. In certain server-based or server-supported implementations, processing unit 610 may, for example, comprise means for receiving one or more first messages comprising one or more parameters indicative of multiple-band capabilities of a receiver of a mobile device, such as to facilitate and/or support operations 402 and/or 404 of FIG. 4, at least in part. In some instances, processing unit 610 may, for example, comprise means for transmitting one or more second messages to the mobile device comprising positioning assistance data determined based, at least in part, on the one or more parameters indicative of the multiple-band capabilities of the receiver of the mobile device, such as to facilitate and/or support operations 402 and/or 404 of FIG. 4, at least in part.

Memory 612 may be representative of any information storage mechanism or appliance. Memory 612 may include, for example, a primary memory 616 and a secondary memory 618. Primary memory 616 may include, for example, a random access memory, read only memory, etc. While illustrated in this example as being separate from processing unit 610, it should be understood that all or part of primary memory 616 may be provided within or otherwise co-located/coupled with processing unit 610. Secondary memory 618 may include, for example, same or similar type of memory as primary memory or one or more information storage devices or systems, such as, for example, a disk drive, an optical disc drive, a tape drive, a solid state memory drive, etc. In certain implementations, secondary memory 618 may be operatively receptive of, or otherwise configurable to couple to, a computer-readable medium 620. Computer-readable medium 620 may include, for example, any non-transitory storage medium that may carry or make accessible information, code, or instructions for one or more of devices in computing environment 600. Computer-readable medium 620 may also be referred to as a machine-readable medium, storage medium, or the like.

Second device 604 may include, for example, a communication interface 622 that may provide for or otherwise support an operative coupling of second device 604 to at least communications network 608. By way of example but not limitation, communication interface 622 may include a network interface device or card, a modem, a router, a switch, a transceiver, and the like. Second device 604 may also include, for example, an input/output device 624. Input/output device 624 may be representative of one or more devices or features that may be configurable to accept or otherwise introduce human or machine inputs, or one or more devices or features that may be capable of delivering or otherwise providing for human or machine outputs. By way of example but not limitation, input/output device 624 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method, at a mobile device, the method comprising:
transmitting one or more messages to a location server, the one or more transmitted messages comprising one or more parameters indicative of at least a multiple-band carrier aggregation capability of the mobile device;
receiving one or more messages from the location server, the one or more received messages comprising positioning assistance data determined based, at least in part, on the one or more parameters indicative of the multiple-band carrier aggregation capability of the mobile device, the positioning assistance data identifying one or more wireless transmitters capable of transmitting a positioning reference signal (PRS) within range of the mobile device;
excluding at least one of the one or more wireless transmitters incompatible with the multiple-band carrier capability of the mobile device to determine at least one neighbor wireless transmitter for acquisition of the PRS; and
searching for the PRS signal transmitted by the at least one neighbor wireless transmitter.

2. The method of claim 1, wherein the one or more transmitted messages are transmitted in connection with a capability transfer procedure.

3. The method of claim 1, wherein the one or more transmitted messages comprise: an LPP Provide Capabilities message; a Multi-Band Carrier Aggregation Capability message; an Information Transfer message, or any combination thereof.

4. The method of claim 1, wherein the one or more parameters are indicative of at least one of: whether the mobile device supports the multiple-band carrier aggregation capability; whether the multiple-band carrier aggregation capability is currently enabled; a number of available downlink carrier aggregation (DLCA) modes; or a type of supported carrier aggregation band combinations, or a combination thereof.

5. The method of claim 1, wherein the positioning assistance data comprises data capable of assisting in acquisition of one or more downlink reference signals from one or more wireless transmitters selected based, at least in part, on the one or more parameters.

6. The method of claim 5, wherein the one or more parameters are capable of assisting in acquisition of the one or more downlink reference signals within a shorter timeframe specified by the location server via a quality of service (QoS) parameter.

7. The method of claim 6, wherein the QoS parameter comprises a maximum response time for responding to the location server with measurements of the one or more downlink reference signals based, at least in part, on one or more of: the multiple-band carrier aggregation capability; or measured power levels of the one or more downlink reference signals, or any combination thereof.

8. The method of claim 7, wherein the measured power levels comprise a reference signal received power (RSRP) level of the one or more downlink reference signals or a reference signal received quality (RSRQ) level of the one or more downlink reference signals.

9. The method of claim 5, wherein the one or more downlink reference signals comprise one or more of: PRS in Long Term Evolution (LTE); 1× signals for in Code Division Multiple Access (CDMA); satellite positioning system (SPS) signals; wireless wide area network (WWAN) signals; a pilot signal, or any combination thereof.

10. The method of claim 1, wherein the positioning assistance data comprises a neighbor list determined based, at least in part, on a ratio of intra-frequency neighbor wireless transmitters to inter-frequency neighbor wireless transmitters selected using the one or more parameters.

11. The method of claim 10, wherein the ratio is further selected based, at least in part, on: a carrier aggregation-supported bands specified by the one or more parameters; a number of carrier aggregation receiver chains specified by the one or more parameters; or an E-UTRA Absolute Radio Frequency Channel Numbers (EARFCNs) specified by the one or more parameters, or any combination thereof.

12. The method of claim 1, wherein the positioning assistance data comprises observed time difference of arrival (OTDOA) assistance data or Advanced Forward Link Trilateration (AFLT) assistance data.

13. The method of claim 1, wherein the positioning assistance data comprises: a neighbor list for performing inter-frequency reference signal time difference (RSTD) measurements; or a neighbor list for performing intra-frequency RSTD measurements, or any combination thereof.

14. The method of claim 1, wherein the multiple-band carrier aggregation capability comprises a capability of the mobile device to combine multiple carrier frequencies across available radio spectrum.

15. The method of claim 14, wherein the mobile device comprises a plurality of receivers capable of receiving or transmitting wireless data simultaneously over more than one carrier frequency in contiguous elements of the available radio spectrum or in different frequency bands.

16. The method of claim 1, wherein the positioning assistance data comprises data capable of shortening a time-to-first fix (TTFF) of the mobile device.

17. The method of claim 1, wherein the positioning assistance data is received according to: a Long Term Evolution (LTE) positioning protocol (LPP); an LPP extensions (LPPe) protocol; or a Secure User Plane Location (SUPL) user plane location protocol (ULP).

18. The method of claim 1, wherein the location server comprises an Enhanced Serving Mobile Location Center (E-SMLC) or a Secure User Plane Location (SUPL) Location Platform (SLP) or emergency SLP (eSLP).

19. An apparatus comprising:
a communication interface coupled to a receiver of a mobile device to communicate with an electronic communications network and one or more processors coupled to a memory and to the communication interface, the communication interface and the one or more processors configured to:
initiate transmission of, via the electronic communications network, one or more messages to a location server, the one or more transmitted messages comprising one or more parameters indicative of at least a multiple-band carrier aggregation capability of the mobile device;
obtain one or more messages from the location server, the one or more received messages comprising positioning assistance data determined based, at least in part, on the one or more parameters indicative of the multiple-band carrier aggregation capability of the mobile device, the positioning assistance data identifying one or more wireless transmitters capable of transmitting a positioning reference signal (PRS) within range of the mobile device;
exclude at least one of the one or more wireless transmitters incompatible with the multiple-band carrier capability of the mobile device to determine at least one neighbor wireless transmitter for acquisition of the PRS; and
search for the PRS signal transmitted by the at least one neighbor wireless transmitter.

20. The apparatus of claim 19, wherein the one or more transmitted messages comprise: an LPP Provide Capabilities message; a Multi-Band Carrier Aggregation Capability message; an Information Transfer message, or any combination thereof.

21. The apparatus of claim 19, wherein the one or more parameters are indicative of at least one of: whether the mobile device supports the multiple-band carrier aggregation capability; whether the multiple-band carrier aggregation capability is currently enabled; a number of available downlink carrier aggregation (DLCA) modes; or a type of supported carrier aggregation band combinations, or a combination thereof.

22. The apparatus of claim 19, wherein the positioning assistance data comprises a neighbor list determined based, at least in part, on a ratio of intra-frequency neighbor wireless transmitters to inter-frequency neighbor wireless transmitters selected using the one or more parameters.

23. The apparatus of claim 19, wherein the positioning assistance data comprises: a neighbor list for performing inter-frequency reference signal time difference (RSTD) measurements; or a neighbor list for performing intra-frequency RSTD measurements, or any combination thereof.

24. A non-transitory storage medium having instructions executable by a processor to:
initiate transmission of one or more messages to a location server, the one or more transmitted messages comprising one or more parameters indicative of at least a multiple-band carrier aggregation capability of a mobile device;
obtain one or more messages from the location server, the one or more obtained messages comprising positioning assistance data determined based, at least in part, on the one or more parameters indicative of the multiple-band carrier aggregation capability of the mobile device, the positioning assistance data identifying one or more wireless transmitters capable of transmitting a positioning reference signal (PRS) within range of the mobile device;
exclude at least one of the one or more wireless transmitters incompatible with the multiple-band carrier capability of the mobile device to determine at least one neighbor wireless transmitter for acquisition of the PRS; and
search for the PRS signal transmitted by the at least one neighbor wireless transmitter.

25. The non-transitory storage medium of claim 24, wherein the one or more transmitted messages comprise: an LPP Provide Capabilities message; a Multi-Band Carrier Aggregation Capability message; an Information Transfer message, or any combination thereof.

26. The non-transitory storage medium of claim 24, wherein the one or more parameters are indicative of at least one of: whether the mobile device supports the multiple-band carrier aggregation capability; whether the multiple-band carrier aggregation capability is currently enabled; a number of available downlink carrier aggregation (DLCA) modes; or a type of supported carrier aggregation band combinations, or a combination thereof.

27. A method, at a computing device, comprising:
receiving one or more first messages comprising one or more parameters indicative of multiple-band capabilities of a receiver of a mobile device; and
transmitting one or more second messages to the mobile device comprising positioning assistance data determined based, at least in part, on the one or more parameters indicative of the multiple-band capabilities of the receiver of the mobile device, the positioning assistance data identifying one or more wireless transmitters capable of transmitting a positioning reference signal (PRS) within range of the mobile device,
the positioning assistance data being transmitted, at least in part, for excluding, by the mobile device, at least one of the one or more wireless transmitters incompatible with the multiple-band carrier capability of the mobile device to determine at least one neighbor wireless transmitter for acquisition of the PRS, and for searching for the PRS signal transmitted by the at least one neighbor wireless transmitter.

28. The method of claim 27, wherein the one or more first messages are transmitted by the mobile device.

29. The method of claim 27, wherein the one or more first messages are transmitted by a wireless transmitter currently serving the mobile device.

30. The method of claim 27, wherein the one or more parameters are indicative of at least one of: whether the receiver supports the multiple-band carrier aggregation capability; whether the multiple-band carrier aggregation capability is currently enabled; a number of receivers available for particular downlink carrier aggregation (DLCA) modes; or a type of supported carrier aggregation band combinations, or a combination thereof.
